(19) United States
(12) Patent Application Publication
(10) Pub. No.: US 2022/0391732 A1
(43) Pub. Date: Dec. 8, 2022

(54) CONTINUOUS OPTIMIZATION OF HUMAN-ALGORITHM COLLABORATION PERFORMANCE

(71) Applicant: International Business Machines Corporation, Armonk, NY (US)

(72) Inventors: Thomas Baudel, Paris (FR); Gregoire Colombet, Saumur (FR)

(21) Appl. No.: 17/338,994

(22) Filed: Jun. 4, 2021

(51) Int. Cl. G06N 5/04; G06F 11/34; G06K 9/62; G06N 20/00

(52) U.S. Cl. CPC G06N 5/045; G06F 11/3428; G06K 9/628; G06N 20/00

(57) ABSTRACT

An approach is provided in which the approach computes a set of thresholds corresponding to a set of decision performances relative to a set of classifier confidence scores. The set of decision performances include a set of user decision performances, a set of classifier decision performances, and a set of augmented decision performances. The approach selects one of the collaboration levels based on comparing the set of thresholds to a new confidence score of a new decision. The approach collaborates with a user at the selected collaboration level to generate a final decision.

### BACKGROUND

Artificial intelligence (AI) uses machine learning algorithms to build models based on sample data (training data) to make predictions or decisions on a topic without being explicitly programmed to make the predictions or decisions on the topic. Machine learning algorithms are used in a wide variety of applications where developing conventional algorithms to perform needed tasks is difficult or unfeasible.

The process of training a machine learning model involves providing a machine learning algorithm with the training data from which to learn, and the artifact created from the training process is the machine learning model. The training data includes correct answers that are referred to as targets or target attributes, and the machine learning algorithm finds patterns in the training data that map input data attributes to the target attributes and outputs a machine learning model that captures the patterns.

The accuracy of a machine learning model is based on its true positives, true negatives, false positives, and false negatives. A true positive is an outcome where the machine learning model correctly predicts a positive class (decision result). A true negative is an outcome where the machine learning model correctly predicts a negative class. A false positive is an outcome where the machine learning model incorrectly predicts a positive class. And, a false negative is an outcome where the machine learning model incorrectly predicts a negative class.

AI-enabled decision automation can be used alone when their machine learning model accuracies clearly outperform human decisions. AI-enabled decision automation can also be used as advisors to raise quality and consistency when the decision requires a human to interpret context.

### BRIEF SUMMARY

According to one embodiment of the present disclosure, an approach is provided that computes a set of thresholds corresponding to a set of decision performances relative to a set of classifier confidence scores. The set of decision performances include a set of user decision performances, a set of classifier decision performances, and a set of augmented decision performances. The approach selects one of the collaboration levels based on comparing the set of thresholds to a new confidence score of a new decision. The approach collaborates with a user at the selected collaboration level to generate a final decision.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present disclosure, as defined solely by the claims, will become apparent in the non-limiting detailed description set forth below.

### BRIEF DESCRIPTION OF THE SEVERAL VIEWS OF THE DRAWINGS

The present disclosure may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is an exemplary diagram depicting a collaboration optimizer system collaborating with a user to generate a decision;

FIG. 4 is an exemplary diagram depicting a graph of an algorithm decision performance plot and a user decision performance plot both relative to an algorithm confidence score;

FIG. 5 is an exemplary diagram depicting a graph of a classifier performance plot, a user performance plot, an augmented performance plot, and various zones corresponding to various collaboration levels;

FIG. 6 is an exemplary diagram depicting an algorithm recommendation available zone and an algorithm recommendation provide zone based on crossover points of an classifier performance plot, a user performance plot, and an augmented performance plot;

FIG. 7 is an exemplary diagram depicting a graph of crossover points and their corresponding collaboration thresholds;

FIG. 8 is an exemplary flowchart showing steps taken to compute various collaboration thresholds; and

FIG. 9 is an exemplary flowchart showing steps taken to provide augmented decision making assistance based on initial classifier confidence scores.

### DETAILED DESCRIPTION

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions. The following detailed description will generally follow the summary of the disclosure, as set forth above, further explaining and expanding the definitions of the various aspects and embodiments of the disclosure as necessary.

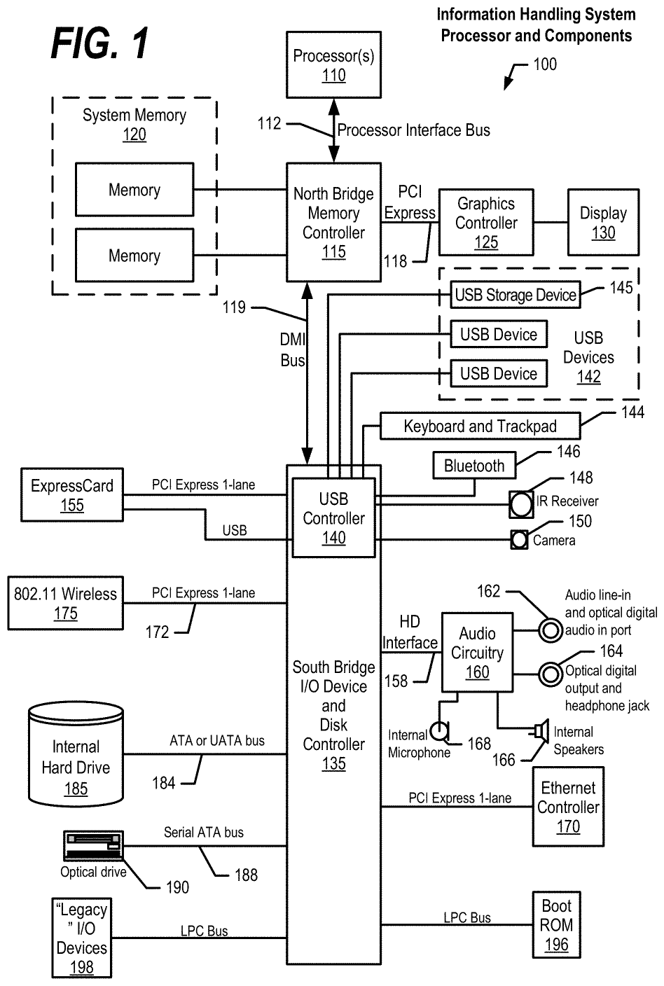

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, Peripheral Component Interconnect (PCI) Express bus 118 connects Northbridge 115 to graphics controller 125. Graphics controller 125 connects to display device 130, such as a computer monitor.

Northbridge 115 and Southbridge 135 connect to each other using bus 119. In some embodiments, the bus is a Direct Media Interface (DMI) bus that transfers data at high speeds in each direction between Northbridge 115 and Southbridge 135. In some embodiments, a PCI bus connects the Northbridge and the Southbridge. Southbridge 135, also known as the Input/Output (I/O) Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and Universal Serial Bus (USB) connectivity as it connects to Southbridge 135 using both the USB and the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, Integrated Services Digital Network (ISDN) connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the Institute of Electrical and Electronic Engineers (IEEE) 802.11 standards of over-the-air modulation techniques that all use the same protocol to wireless communicate between information handling system 100 and another computer system or device. Optical storage device 190 connects to Southbridge 135 using Serial Analog Telephone Adapter (ATA) (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality associated with audio hardware such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, Automated Teller Machine (ATM), a portable telephone device, a communication device or other devices that include a processor and memory.

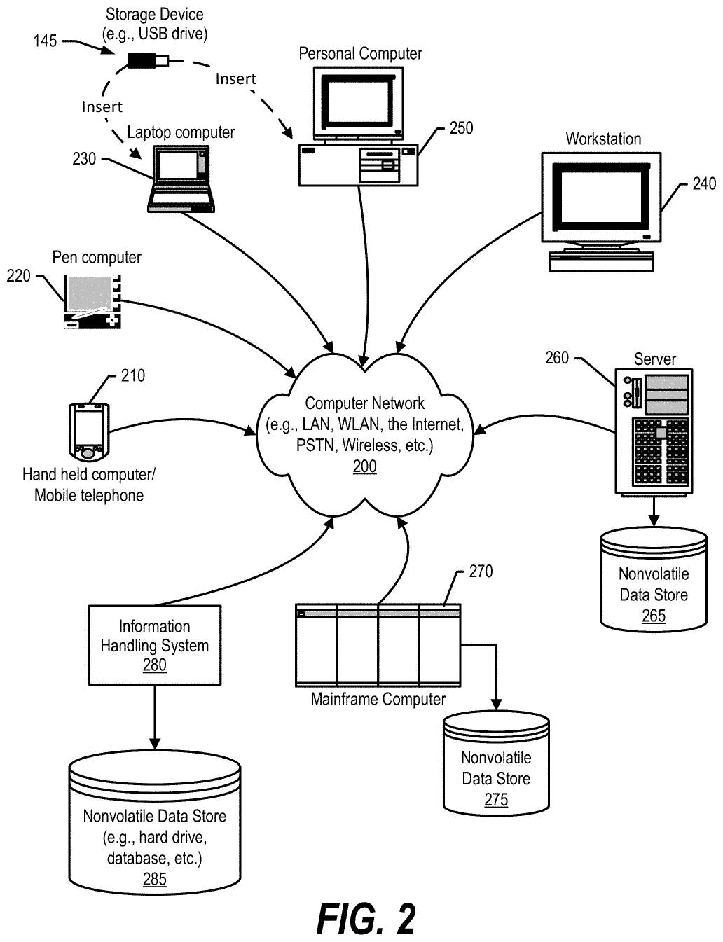

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as Moving Picture Experts Group Layer-3 Audio (MP3) players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. The embodiment of the information handling system shown in FIG. 2 includes separate nonvolatile data stores (more specifically, server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

As discussed above, AI-enabled decision automation may be used alone when their machine learning model accuracies clearly outperform human decisions, and can also be used as advisors to raise quality and consistency when the decision requires a human (referred to herein as a “user”) to interpret context. A challenge found, however, is that insufficient or excessive performance of machine learning models has shown to be detrimental to collaborative decision-making and generating automation biases. When deploying an algorithm to substitute or complement user decision-making, guarantees of performance and bias control are needed as well as a methodology to collect and monitor those metrics over time. In addition, the collected metrics can be used to determine the optimal user/algorithm collaboration combination that maximizes the performance/risk ratio.

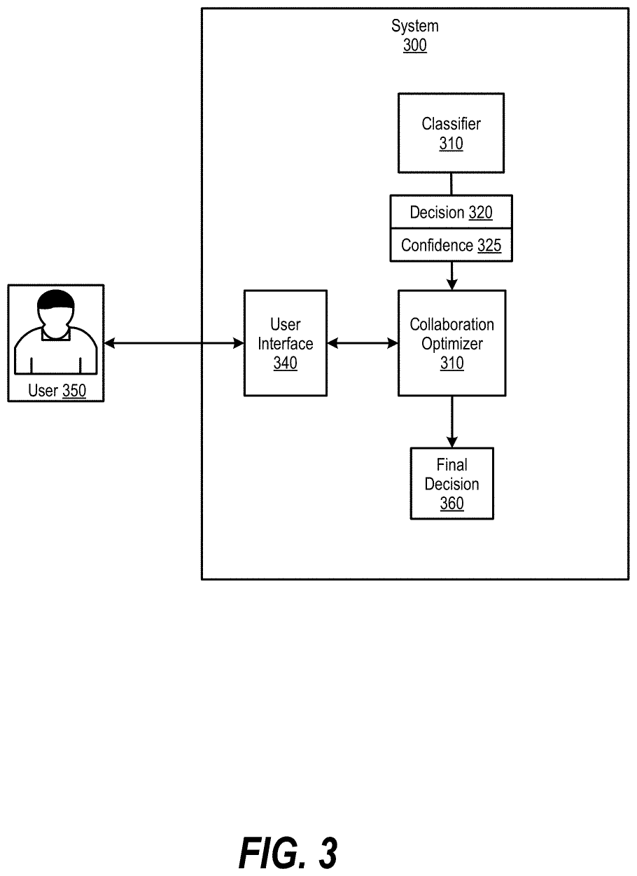

FIGS. 3 through 9 depict an approach that can be executed on an information handling system that enables an augmented decision process to measure the quality of decisions over time and provide correct augmented user guidance. The approach relies on an algorithmic classifier to provide a decision and a decision confidence score. Then, based on the confidence score, the approach i) accepts the classifier's decision as a final decision; ii) provides, or makes available, a recommendation to a user and accepts the user's decision as a final decision; or iii) enables the user to provide a decision without the classifier's recommendation. The approach monitors global performance and bias measures to continuously adjust the distributions of decisions to provide robust guarantees of performance, cost, and bias remediation.

In one embodiment, the approach defines metrics of performance, user-algorithm collaboration, biases and resistance, and a setup of controlled experiments to measure the metrics in a given combination of task and algorithmic decision aid. Then, the approach uses the intersection of computed confidence plots to determine which decision method to follow.

FIG. 3 is an exemplary diagram depicting a collaboration optimizer system collaborating with a user to generate a decision. As discussed herein, a machine learning model (e.g., classifier 310) is trained to produce accurate decisions. At times, however, classifier 310 is unsure of the decision (confidence 325) and, at these times, collaboration optimizer 310 interacts with user 350 to generate a best case final decision 360.

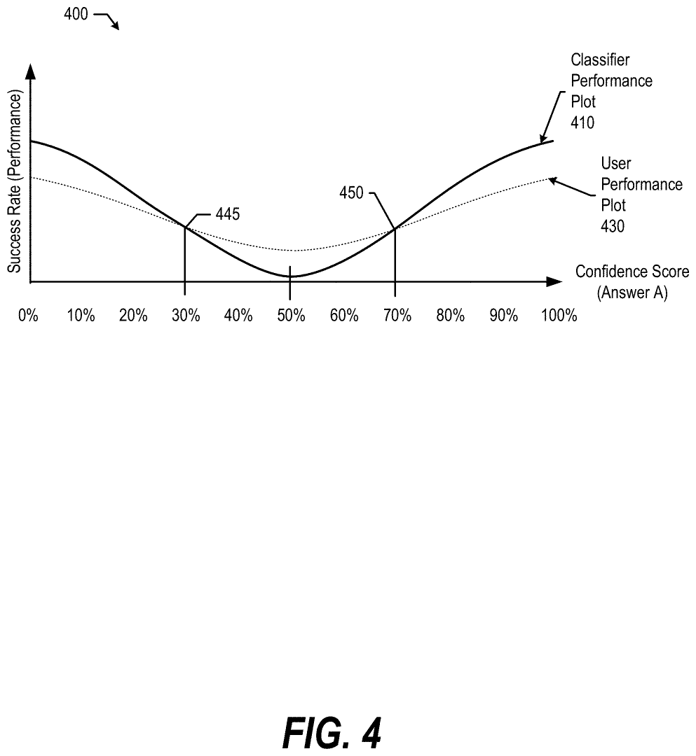

Referring to FIG. 4, FIG. 4 plots the classifier decision performance of classifier 310 for a binary decision against its own level of confidence to obtain classifier performance plot 410 where performance is high when classifier 310's confidence is high for a given answer as well as when classifier 310's confidence is low for a given answer (indicating a different answer). FIG. 4 superimposes user performance plot 430 on graph 400, which is a user decision performance of user 350 for the same task, to identify crossover points 445 and 450 of the two plots. Graph 400 shows that user 350 performs better when confidence 325 is unsure (50%), possibly because user 350 attempts to leverage more context, external information, etc. to refine the decisions. Conversely, when confidence 325 is high or low, classifier 310 produces more accurate answers because classifier 310 is not subject to inattention, fatigue or other cognitive biases.

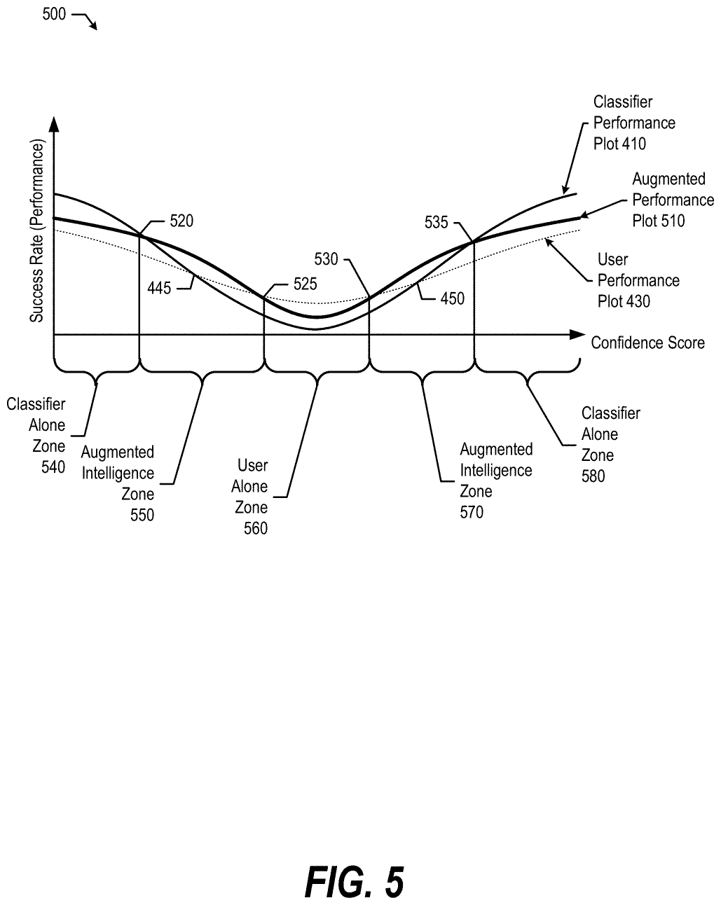

System 300, in one embodiment, generates graph 400 shown in FIG. 4 to determine crossover points 445 and 450. In addition, and as discussed in detail below, system 300 generates an augmented decision performance plot of when classifier 310 and user 350 collaborate to generate a decision, referred to herein as an augmented performance (See FIG. 5, plot 510, and corresponding text for further details). FIGS. 4 through 7 depict various plots and crossover points that system 300 computes, which collaboration optimizer 310 uses to select appropriate augmented user guidance.

The crossover points create four different confidence score “zone types” that dictate how collaboration optimizer 310 interacts with user 350, referred to herein as collaboration levels (see FIGS. 5 through 7 and corresponding text for further details). The first zone type is a classifier alone zone type. In this zone, collaboration optimizer 310 uses decision 320 to generate final decision 360 without user 350 involvement. The second zone type is a user alone zone type. In this zone, collaboration optimizer 310 receives an answer from user 350 and uses user 350's answer as final decision 360. The third zone type is a classifier recommendation available zone type. In this zone, collaboration optimizer 310 informs user 350 that a recommendation (decision 320 and confidence 325) is available if requested to make a decision. The fourth zone type is a classifier recommendation provided zone type. In this zone, collaboration optimizer 310 automatically provides the recommendation from classifier 310 to user 350.

Once system 300 establishes the crossover points and identifies the different zones of the different collaboration levels, collaboration optimizer 310 receives decision 320 and confidence 325 from classifier 310. Then, by choosing how to handle decisions, collaboration optimizer 310 either uses classifier 310's decision as final decision 360; collaborates with user 350 with a provided/available recommendation; or receives a user only answer from user 350 to generate final decision 360. System 300 also monitors global performance and measures of biases to continuously adjust the distributions of decisions to make so as to provide robust guarantees of performance, cost and bias remediation.

In one embodiment, the performance of a binary decision system meeting requirements is modeled with an equation similar to:

P=(1−Eₙ)Gₙ+(1−Eₚ)Gₚ-CₚEₚ−CₙEₙ−Cₜ
Given a cost matrix:
Cₚ: Cost of misclassification of a positive;
Cₙ: Cost of misclassification of a negative;
Gₚ: Positive identification gain;
Gₙ: Correct negative identification gain;
Cₜ: Average cost of treatment (typically user time and amortized time to develop decision aid solution);
Eₙ, Eₚ: Estimated error rates.

In one embodiment, system 300 takes into account automation bias in how a wrong recommendation influences user 350 to let user 350 lose their rationality. Automation bias can be separated into to two sub-categories. The first category is authority bias where a user 350 follows (wrongly) classifier 310's decision instead of user 350's own reasoning because user 350 perceives themselves as less accurate. The second category is complacency bias where user 350 follows (wrongly) classifier 310's decision out of a lack of motivation.

Automation bias, as defined herein, is the probability that a user who sees a wrong recommendation makes a non-rational decision, knowing the user would have made a rational decision if not being presented a recommendation. Automation bias is measured via a controlled experiment and false recommendations are sometimes provided. Automation bias is computed as the ratio of extra errors when wrong recommendations are presented over the number of wrong answers when no recommendation is provided. Resistance to automation bias is measured via the same controlled experiment and computed as the success rate when bad recommendations are given over the success rate when a good recommendation is provided.

FIG. 4 is an exemplary diagram depicting a graph of a classifier performance plot and a user performance plot relative to classifier confidence scores.

Classifier performance plot 410 is a performance logistic curve of a decision classifier for a binary decision (answer “A”) against its own level of confidence. Classifier performance plot 410 shows that classifier 310's success rate is high when confidence of an answer is high (high probability that answer A is correct), and when confidence of an answer is low (low probability that answer A is correct, indicating that answer B is correct). Classifier performance plot 410 also shows that the success rate drops when the classifier is unsure of an answer (e.g., between 30%-70% confidence).

Graph 400 superimposes the performance of a set of users for the same task to obtain user performance plot 430. User performance plot 430 is a performance logistic curve of a user for a binary decision (answer “A”) against classifier 310's level of confidence. User performance plot 430 has two crossover points with classifier performance plot 410, which are point 445 (˜30% confidence score) and 450 (˜70% confidence score). Between crossover points 445 and 450, user performance plot 430 shows that the success rate is higher when a user makes a decision instead of a classifier. However, with confidence scores above crossover point 450 and below crossover point 445, classifier 310 has increased decision-making success over user 350. As discussed herein, the crossover points are dependent on the task and information available, which system 300 determines for specific combinations of available information, algorithms, and tasks.

To determine crossover points 445 and 450, system 300 first constructs a controlled experiment and provides user 350 with artificially crafted test cases to determine the shape and intersection of the plots. Once the plots are traced, system 300 has a quantitative, empirical evidence of the performance gains to expect from the assignment of high confidence decisions to classifier 310 and delegation to user 350 for complex decisions.

FIG. 5 is an exemplary diagram depicting a graph of decision performance plots and various zones corresponding to various collaboration levels. As discussed above, user 350 performs better than classifier 310 when the confidence of classifier 310 is unsure (30-50%), such as by attempting to leverage more context, external information, to refine their decisions. Conversely, when the confidence of classifier 310 is high/low, classifier 310 is most likely more reliable than user 350.

Graph 500 shows augmented performance plot 510, which is a plot of performance when classifier 310 collaborates with user 350 in some manner to generate a decision. Augmented performance plot 510 produces four crossover points 520, 525, 530, and 535 on graph 500. Confidence scores less than crossover point 520 fall into classifier alone zone 540 because classifier performance plot 410 has the highest confidence value in this zone. As such, when classifier 310 generates a decision with a confidence score within classifier alone zone 540, collaboration optimizer 310 selects classifier decision 320 as the final decision 360.

Likewise, confidence scores greater than crossover point 535 fall into the classifier alone zone 580 because classifier performance plot 410 has the highest confidence value in this range (similar to classifier alone zone 540). As such, when classifier 310 generates a decision with a confidence score within classifier alone zone 580, collaboration optimizer 310 selects classifier decision 320 as the final decision 360.

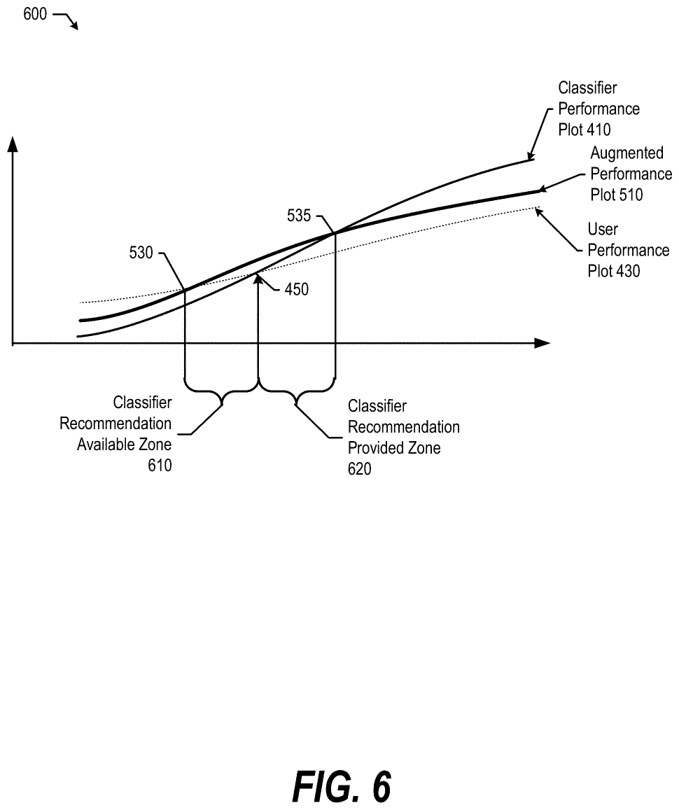

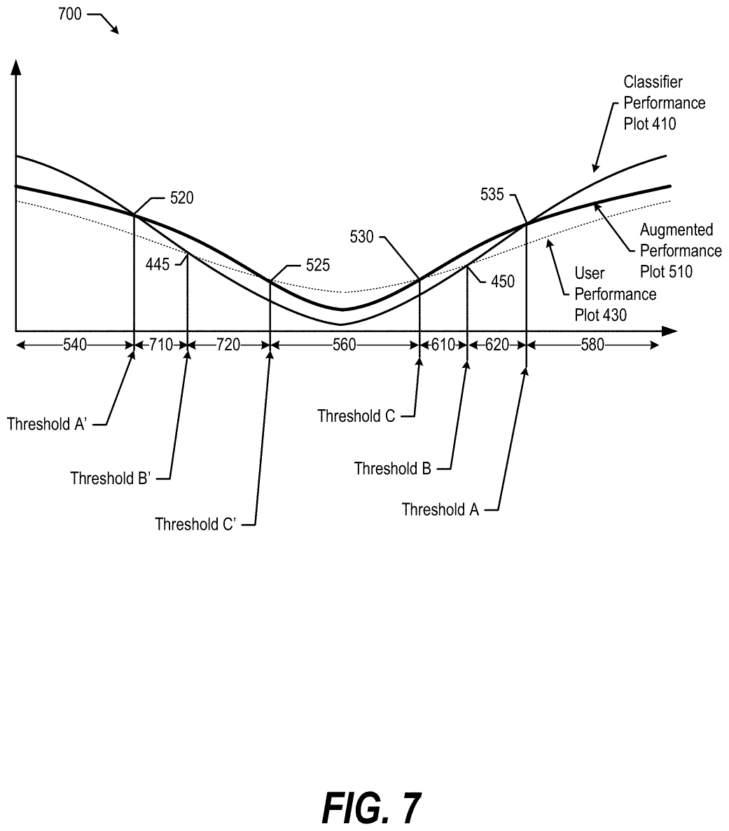

Confidence scores between crossover point 520 and 525 fall into the augmented intelligence zone 550 because augmented performance plot 510 has the highest confidence value in this range. As such, when classifier 310 generates a decision with a confidence score within augmented intelligence zone 550, collaboration optimizer 310 collaborates with user 350 to derive a final decision. In one embodiment, the level of interaction depends upon whether the confidence score is less than or greater than crossover point 445 (see FIGS. 6, 7, and corresponding text for further details).

Likewise, confidence scores between 530 and 535 fall into the augmented intelligence zone 570 because augmented performance plot 510 has the highest confidence value in this range (similar to augmented intelligence zone 550). As such, when classifier 310 generates a decision with a confidence score within augmented intelligence zone 570, collaboration optimizer 310 collaborates with user 350 to derive final decision 360 and, in one embodiment, the level of interaction depends upon whether the confidence score is less than or greater than crossover point 450 (see FIGS. 6, 7, and corresponding text for further details).

Confidence scores between 525 and 530 fall into the user alone zone 560 because user performance plot 430 has the highest confidence value in this range. As such, when classifier 310 generates a decision with a confidence score within user alone zone 560, collaboration optimizer 310 receives a final decision from user 350 without providing classifier decision information to user 350.

FIG. 6 is an exemplary diagram depicting a classifier recommendation available zone and a classifier recommendation provided zone based on crossover points of a classifier performance plot, a user performance plot, and an augmented performance plot.

Graph 600 segments augmented intelligence zone 570 into classifier recommendation available zone 610 and classifier recommendation provided zone 620 based on crossover point 450. Within classifier recommendation available zone 610, user performance plot 430 is slightly higher than classifier performance plot 410, indicating that user 350 has a slight advantage of making a correct decision over classifier 310. As such, when classifier 310 generates a decision with a confidence score within classifier recommendation available zone 610, collaboration optimizer 310 informs user 350 that a recommendation is available (decision 320 and confidence 325) but waits until user 350 requests the recommendation before providing the recommendation to user 350.

Within classifier recommendation provided zone 620, classifier performance plot 410 is slightly higher than user performance plot 430, indicating that classifier 310 has a slight advantage over user 350 of making a correct decision. As such, when classifier 310 generates a decision with a confidence score within classifier recommendation provided zone 620, collaboration optimizer 310 provides a recommendation to user 350 so that user 350 factors the recommendation into user 350's decision process.

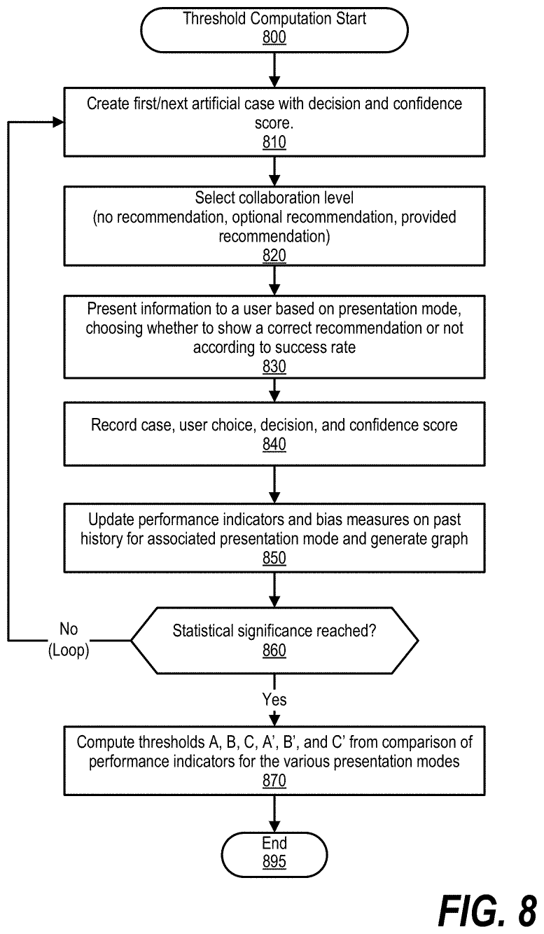

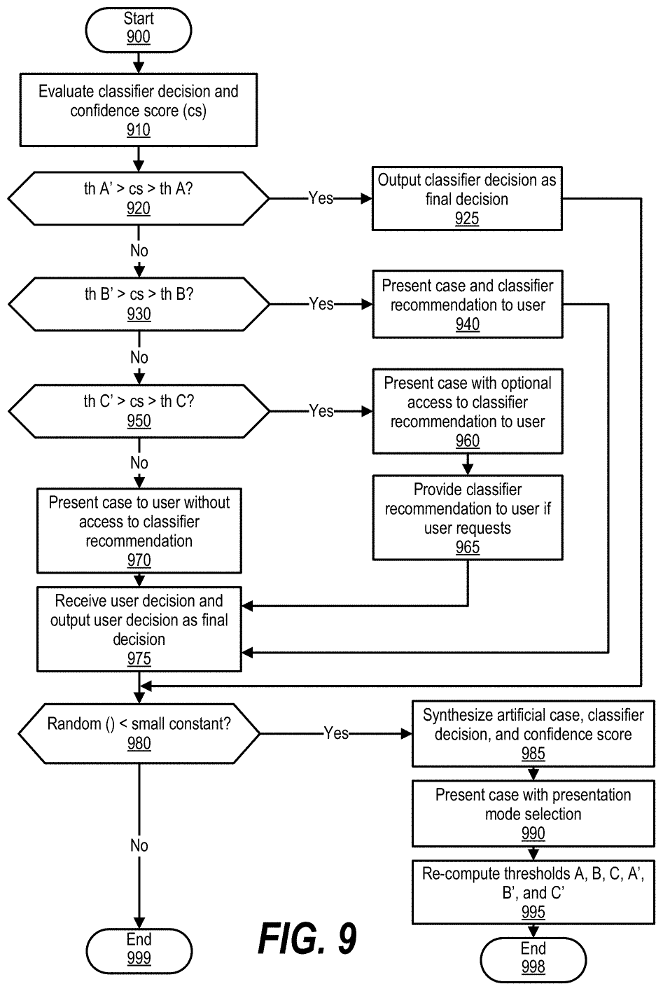

FIG. 7 is an exemplary diagram depicting a graph of crossover points and their corresponding collaboration thresholds as discussed herein. Graph 700 combines crossover points and zones from FIGS. 4 through 6 and adds “collaboration thresholds” of corresponding confidence scores. As discussed herein, collaboration optimizer 310 computes and dynamically adjusts the collaboration thresholds over time as needed (see FIGS. 8, 9, and corresponding text for further details).

As shown in FIG. 5 and discussed in the corresponding text above, confidence scores greater than crossover point 535 fall into classifier alone zone 580 because classifier performance plot 410 has the highest confidence value in this range. Crossover point 535 corresponds to threshold A, such as a 90% confidence score. Similarly, confidence scores less than crossover point 520 fall into the classifier alone zone 540. Crossover point 520 corresponds to threshold A′ that, in one embodiment, equals 100-threshold A. For example, if threshold A is computed to be 90%, 100-threshold A is 10% and corresponds to crossover point 520. In another embodiment, the plots may not be symmetrical and crossover point 520 may be a different value than 100-threshold A (see FIG. 8 and corresponding text for further details).

As shown in FIG. 6 and discussed in the corresponding text above, confidence scores between crossover point 450 and 535 fall in classifier recommendation provided zone 620. Crossover point 450 corresponds to threshold B, such as a 70% confidence score. Similarly, confidence scores between 445 and 520 fall into the classifier recommendation provided zone 710. Crossover point 445 corresponds to threshold B′ that, in one embodiment, may be 100-threshold B. For example, if threshold B is computed to be 70%, 100-threshold B is 30% and corresponds to crossover point 445.

As shown in FIG. 5 and discussed in the corresponding text above, confidence scores between crossover points 525 and 530 fall into user alone zone 560 because user performance plot 430 has the highest confidence value in this range. Crossover point 530 corresponds to threshold C, such as a 60% confidence score. Crossover point 525 corresponds to threshold C′ and, in one embodiment, corresponds to 100-threshold C. For example, if threshold C is computed to be 60%, 100-threshold C is 40% and corresponds to crossover point 525.

FIG. 8 is an exemplary flowchart showing steps taken to determine decision performances and compute various collaboration thresholds. FIG. 8 processing commences at 800 whereupon, at step 810, the process creates a first artificial case with a decision result and a confidence score.

At step 820, the process selects a collaboration level (no recommendation, optional recommendation, provided recommendation). In one embodiment, the process randomly chooses a collaboration level among the possible options in a uniform distribution. Then, as the performance indicators for each collaboration level updates, the process slowly increases the probability of choosing the collaboration levels for which statistical significance has been reached. For example, the process may require 100 test cases per presentation mode to have a p-value<0.05, but may sometimes require more test cases when the decisions are of unequal difficulty. The p-value is a measure of the probability that an observed difference could occur by random chance. The lower the p-value, the greater the statistical significance of the observed difference.

At step 830, the process presents information to user 350 via user interface 340. The process chooses whether to provide a correct recommendation to user 350 according to an average success rate expected of classifier 310. For example, if classifier 310 tends to have a 75% success rate, the process presents a wrong recommendation 25% of the time in a randomized manner. In one embodiment, the process varies the rate of wrong recommendations to refine the measurements and gain in precision. In this embodiment, the process varies various parameters in small increments to see how a combined system-user classifier collaboration reacts to changes to the feed of decisions to make.

At step 840, the process records the case, the user choice, the decision result, and the confidence score. At step 850, the process updates performance indicators and bias measures on past history for the associated presentation mode and, in one embodiment, generates a graph that includes classifier performance plot 410, user performance plot 430, and augmented performance plot 510. In one embodiment, the graph is computed by taking past and current inputs and grouping those inputs by confidence of classifier 310. In this embodiment, each new input case may cause a small adjustment of the curves, and the process concludes when the adjustments are maintained within the acceptable margins of error (e.g., p-value<0.05) and statistical significance is reached.

The process determines as to whether statistical significance has been reached for each collaboration level (decision 860). If statistical significance is not reached, then decision 860 branches to the ‘no’ branch which loops back to create and process a next artificial case. This looping continues until statistical significance is reached at each collaboration level, at which point decision 860 branches to the ‘yes’ branch exiting the loop.

At step 870, the process computes collaboration thresholds A, B, C, A′, B′, and C′ based on crossover points of the various presentation modes (see FIG. 7 and corresponding text for further details) and FIG. 8 processing thereafter ends at 895.

FIG. 9 is an exemplary flowchart showing steps taken to provide augmented decision making assistance to user 350 based on classifier confidence scores. FIG. 9 processing commences at 900 whereupon, at step 910, the process evaluates classifier decision 320 and a confidence score 325 (cs) generated by classifier 310. The process determines as to whether the confidence score is greater than collaboration threshold A or less than collaboration threshold A′ (decision 920). For example, if collaboration threshold A is 90%, then the process determines if the confidence score is greater than 90% or less than 10% (100-90). Referring to FIG. 7, decision 920 determines whether the confidence score falls within classifier alone zones 540 or 580.

If the confidence score is greater than collaboration threshold A or less than collaboration threshold A′, then decision 920 branches to the ‘yes’ branch whereupon, at step 925, the process outputs classifier decision 320 as final decision 360.

On the other hand, if the confidence score is not greater than collaboration threshold A, or not less than collaboration threshold A′, then decision 920 branches to the ‘no’ branch. The process determines as to whether the confidence score is greater than collaboration threshold B or less than collaboration threshold B′ (decision 930). Referring to FIG. 7, decision 930 determines whether the confidence score falls within classifier recommendation provided zones 620 or 720. If the confidence score is greater than collaboration threshold B or less than collaboration threshold B′, then decision 930 branches to the ‘yes’ branch whereupon, at step 940, the process presents the case and classifier recommendation (includes classifier decision 320 and confidence score 325) to user 350. Then, at step 975, the process receives the user decision and outputs the user decision as final decision 360 accordingly.

On the other hand, if the confidence score is not greater than collaboration threshold B or not less than collaboration threshold B′, then decision 930 branches to the ‘no’ branch. The process determines as to whether the confidence score is greater than collaboration threshold C or less than collaboration threshold C′ (decision 950). Referring to FIG. 7, decision 930 determines whether the confidence score falls within classifier recommendation available zones 610 or 710.

If the confidence score is greater than collaboration threshold C or less than collaboration threshold C′, then decision 950 branches to the ‘yes’ branch whereupon, at step 960, the process presents the case with optional access to classifier 310's recommendation to user 350. At step, 965, the process provides the classifier recommendation to user 350 if user 350 requests the recommendation. Otherwise the process does not provide the classifier recommendation to user 350. Then, at step 975, the process receives the user decision and outputs the user decision as final decision 360 accordingly.

Referring back to decision 950, If the confidence score is not greater than collaboration threshold C or not less than collaboration threshold C′, then decision 950 branches to the ‘no’ branch, indicating that the confidence score is in user alone zone 560 (see FIG. 7 and corresponding text for further details). As such, at step 960, the process presents the case to user 350 without access to the classifier recommendation. At step 975, the process receives the user decision and outputs the user decision as final decision 360.

The process generates a random number and determines as to whether the random number is less than a small constant (decision 980). In one embodiment, the small constant is a design choice based on operational conditions. The process determines the number of times to present artificial cases based on the workload of user 350. For example, if user 350 is busy, the process may not provide artificial test cases. However, if user 350 is idle, the process may provide artificial test cases to keep user 350 engaged in a task. In one embodiment, the process partially repeats to adjust the calibration. The decision (random( )<small constant) is the decision process of whether or not to prompt a user for an artificial case.

If the random number is not less than a small constant, then decision 980 branches to the ‘no’ branch whereupon FIG. 9 processing thereafter ends at 999. On the other hand, the random number is less than a small constant, then decision 980 branches to the ‘yes’ branch whereupon, at step 985, the process synthesizes an artificial case, classifier decision, and confidence score. At step 990, the process presents case at a selected collaboration level similar to step 820 discussed above. At step 995, the process re-computes thresholds A, B, and C similar to step 850 discussed above based on decisions from user 350. FIG. 9 processing thereafter ends at 998.

While particular embodiments of the present disclosure have been shown and described, it will be obvious to those skilled in the art that, based upon the teachings herein, that changes and modifications may be made without departing from this disclosure and its broader aspects. Therefore, the appended claims are to encompass within their scope all such changes and modifications as are within the true spirit and scope of this disclosure. Furthermore, it is to be understood that the disclosure is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to disclosures containing only one such element, even when the same claim includes the introductory phrases “one or more” or “at least one” and indefinite articles such as “a” or “an”; the same holds true for the use in the claims of definite articles.

1. A method implemented by an information handling system that includes a memory and a processor, the method comprising:
computing a set of thresholds corresponding to a set of decision performances relative to a set of classifier confidence scores, wherein the set of decision performances comprise a set of user decision performances, a set of classifier decision performances, and a set of augmented decision performances;
selecting one of a plurality of collaboration levels based on comparing the set of thresholds to a new confidence score of a new decision; and
collaborating with a user at the selected collaboration level to generate a final decision.

2. The method of claim 1 further comprising:
generating a user performance plot of a user based on the set of user decision performances, wherein the generating further comprises:
analyzing a plurality of outcomes of a plurality of previous decisions made by the user;
assigning a set of user performance values, based on the analysis, to a plurality of intervals of the set of classifier confidence scores, wherein the set of user performance values reflect a success of the plurality of outcomes of the plurality of previous decisions; and
inferring the user performance plot based on the plurality of performance values at the plurality of intervals of the set of classifier confidence scores.

3. The method of claim 2 further comprising:
generating a classifier performance plot of a classifier based on the set of classifier decision performances;
generating an augmented performance plot based on the set of augmented decision performances, wherein the set of augmented decision performances are based on a collaboration between the user and the classifier; and
determining the set of thresholds based on a set of intersections between the user performance plot, the classifier performance plot, and the augmented performance plot.

4. The method of claim 1 wherein at least one of the plurality of collaboration levels are selected from the group consisting of a user alone collaboration level, a classifier alone collaboration level, a classifier recommendation available collaboration level, and a classifier recommendation provided collaboration level.

5. The method of claim 1 wherein the set of user decision performances are based on a decision accuracy of a user, the set of classifier decision performances are based in a decision accuracy of a classifier, and the set of augmented decision performances are based on a decision accuracy of the user with assistance from the classifier.

6. The method of claim 1 further comprising:
determining at least one of the set of crossover points as an automation bias crossover point, wherein the automation bias crossover point indicates a point at which the user performs better without a classifier recommendation.

7. The method of claim 1 wherein determining the new confidence score for the new decision further comprises:
inputting a new question into a classifier configured to issue the new decision and the new confidence score, wherein a degree of confidence of the new decision corresponds to the new confidence score.

8. The method of claim 1 further comprising:
receiving a new set of decisions from a user in response to providing a new set of questions to the user; and
re-computing the set of thresholds based on the new set of decisions.

9. An information handling system comprising:
one or more processors;
a memory coupled to at least one of the processors;
a set of computer program instructions stored in the memory and executed by at least one of the processors in order to perform actions of:
computing a set of thresholds corresponding to a set of decision performances relative to a set of classifier confidence scores, wherein the set of decision performances comprise a set of user decision performances, a set of classifier decision performances, and a set of augmented decision performances;
selecting one of a plurality of collaboration levels based on comparing the set of thresholds to a new confidence score of a new decision; and
collaborating with a user at the selected collaboration level to generate a final decision.

10. The information handling system of claim 9 wherein the processors perform additional actions comprising:
generating a user performance plot of a user based on the set of user decision performances, wherein the generating further comprises:
analyzing a plurality of outcomes of a plurality of previous decisions made by the user;
assigning a set of user performance values, based on the analysis, to a plurality of intervals of the set of classifier confidence scores, wherein the set of user performance values reflect a success of the plurality of outcomes of the plurality of previous decisions; and
inferring the user performance plot based on the plurality of performance values at the plurality of intervals of the set of classifier confidence scores.

11. The information handling system of claim 10 wherein the processors perform additional actions comprising:
generating a classifier performance plot of a classifier based on the set of classifier decision performances;
generating an augmented performance plot based on the set of augmented decision performances, wherein the set of augmented decision performances are based on a collaboration between the user and the classifier; and
determining the set of thresholds based on a set of intersections between the user performance plot, the classifier performance plot, and the augmented performance plot.

12. The information handling system of claim 9 wherein at least one of the plurality of collaboration levels are selected from the group consisting of a user alone collaboration level, a classifier alone collaboration level, a classifier recommendation available collaboration level, and a classifier recommendation provided collaboration level.

13. The information handling system of claim 9 wherein the set of user decision performances are based on a decision accuracy of a user, the set of classifier decision performances are based in a decision accuracy of a classifier, and the set of augmented decision performances are based on a decision accuracy of the user with assistance from the classifier.

14. The information handling system of claim 9 wherein the processors perform additional actions comprising:
determining at least one of the set of crossover points as an automation bias crossover point, wherein the automation bias crossover point indicates a point at which the user performs better without a classifier recommendation.

15. The information handling system of claim 9 wherein the processors perform additional actions comprising:
inputting a new question into a classifier configured to issue the new decision and the new confidence score, wherein a degree of confidence of the new decision corresponds to the new confidence score.

16. A computer program product stored in a computer readable storage medium, comprising computer program code that, when executed by an information handling system, causes the information handling system to perform actions comprising:
computing a set of thresholds corresponding to a set of decision performances relative to a set of classifier confidence scores, wherein the set of decision performances comprise a set of user decision performances, a set of classifier decision performances, and a set of augmented decision performances;
selecting one of a plurality of collaboration levels based on comparing the set of thresholds to a new confidence score of a new decision; and
collaborating with a user at the selected collaboration level to generate a final decision.

17. The computer program product of claim 16 wherein the information handling system performs further actions comprising:
generating a user performance plot of a user based on the set of user decision performances, wherein the generating further comprises:
analyzing a plurality of outcomes of a plurality of previous decisions made by the user;
assigning a set of user performance values, based on the analysis, to a plurality of intervals of the set of classifier confidence scores, wherein the set of user performance values reflect a success of the plurality of outcomes of the plurality of previous decisions; and
inferring the user performance plot based on the plurality of performance values at the plurality of intervals of the set of classifier confidence scores.

18. The computer program product of claim 17 wherein the information handling system performs further actions comprising:
generating a classifier performance plot of a classifier based on the set of classifier decision performances;
generating an augmented performance plot based on the set of augmented decision performances, wherein the set of augmented decision performances are based on a collaboration between the user and the classifier; and
determining the set of thresholds based on a set of intersections between the user performance plot, the classifier performance plot, and the augmented performance plot.

19. The computer program product of claim 16 wherein at least one of the plurality of collaboration levels are selected from the group consisting of a user alone collaboration level, a classifier alone collaboration level, a classifier recommendation available collaboration level, and a classifier recommendation provided collaboration level.

20. The computer program product of claim 16 wherein the information handling system performs further actions comprising:
inputting a new question into a classifier configured to issue the new decision and the new confidence score, wherein a degree of confidence of the new decision corresponds to the new confidence score.
